(19) United States
(12) Patent Application Publication
(10) Pub. No.: US 2009/0195757 A1
(43) Pub. Date: Aug. 6, 2009

(54) PROJECTOR WITH ZONE COOLING CONFIGURATION AND METHOD FOR COOLING A PROJECTOR USING ZONE COOLING CONFIGURATION

(75) Inventors: CHIEN-FU CHEN, Tu-Cheng (TW); WEI-PING HSU, Tu-Cheng (TW); YUN-LIANG CHU, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/118,984

(22) Filed: May 12, 2008

(30) Foreign Application Priority Data
Feb. 1, 2008 (CN) 200810300308.2

(51) Int. Cl. G03B 21/16

(52) U.S. Cl. 353/58

(57) ABSTRACT

A projector includes a light source, a color wheel, and a Digital Mirror Device. The color wheel is configured for providing rapid color changes in light emitted from the light source. The Digital Mirror Device is configured for forming an optical image according to image information by using light emitted from the light source. The projector includes a first airflow channel and a second airflow channel. The first airflow channel is configured for cooling the light source and the color wheel. The second airflow channel is configured for cooling the Digital Mirror Device. The first airflow channel and the second airflow channel are independent to each other. A method for cooling a projector using zone cooling is also provided.

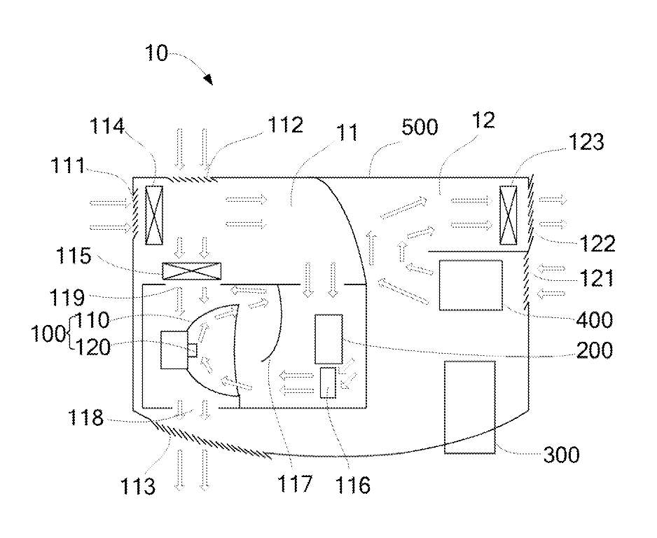

### TECHNICAL FIELD

The present invention relates to projectors, and particularly to a projector with zone cooling configuration.

### DESCRIPTION OF RELATED ART

Projectors typically include heat-generating members, such as a light source, and the inside of the projector needs to be efficiently cooled. Conventional cooling configurations usually maintain the inside chamber or enclosure of the projector at about the same temperature and may not take into consideration the different working temperature requirements of individual components. As such, components may operate outside of their ideal operating temperature resulting in instability in the performance of the components.

What is needed, therefore, is a projector with a cooling configuration to cool particular areas or zones of the enclosure of the projector.

### SUMMARY

In accordance with one present embodiment, a projector includes a light source, a color wheel, and a Digital Mirror Device (DMD). The color wheel is configured for providing rapid color changes in light emitted from the light source. The Digital Mirror Device is configured for forming an optical image according to image information by using the light emitted from the light source. The projector further includes a first airflow channel and a second airflow channel. The first airflow channel is configured for cooling the light source and the color wheel. The second airflow channel is configured for cooling the Digital Mirror Device. The first airflow channel and the second airflow channel are independent of each other. A method for cooling a similarly structured projector using multiple airflow channels by using different airflow channel to cool different components of the projector.

### BRIEF DESCRIPTION OF THE DRAWING

Many aspects of the present projector can be better understood with reference to the following drawings. The components in the drawings are not necessarily drawn to scale, the emphasis instead being placed upon clearly illustrating the principles of the present projector.

The drawing is a plan view of a projector according to a present embodiment of the present invention.

### DETAILED DESCRIPTION OF THE EMBODIMENTS

Embodiments of the present invention will now be described in detail below, with reference to the accompanying drawing.

Referring to the drawing, a projector 10, according to an embodiment is shown. The projector 10 includes a casing 500 substantially enclosing a light source 100, a color wheel 200, a projection lens 300, and a Digital Mirror Device (DMD) 400.

The light source 100 includes a reflector 110 and a lamp 120 received in the reflector 110. The light source 100 is a primary heat source of the projector 10. The light source 100 can withstand relatively high temperatures.

The color wheel 200 is aligned with the lamp 120. The color wheel 200 is configured for providing rapid color changes in reaction to the light emitted from the lamp 120.

The DMD 400 is configured for forming an optical image according to image information by using light emitted from the light source 100.

The projection lens 300 is configured for enlarging and projecting the optical image formed by the DMD 400.

The projector 10 has a first airflow channel 11 and a second airflow channel 12. The light source 100 and the color wheel 200 are disposed in the first airflow channel 11, and the DMD 400 is disposed in the second airflow channel 12.

In the present embodiment, the first airflow channel 11 includes two air inlets 111, 112 and an air outlet 113 formed in the casing 500. A first fan 114, a second fan 115, and a blower 116 are disposed in the casing 500 along the first airflow channel 11. The first fan 114 is aligned with the air inlet 111, in this embodiment the first fan 114 is attached to the air inlet 111 in order to improve the flow rate the air coming from the air inlet 111.

In the first airflow channel 11, a portion of air coming from the two air inlets 111, 112 is directed by the first fan 114, to flow toward the color wheel 200, the lamp 120, and the outer surface of the reflector 110 in sequence, then passes a first hole 118 and exit the projector 10 from the air outlet 113. The air flows around the lamp 120 along the inner surface of the reflector 110, so that the inner surface of the reflector 110 can be cooled. The blower 116 is configured for directing air, flowing toward the color wheel 200, to the lamp 120. In the present embodiment, the blower blows the air onto one side/edge of the inner surface of the reflector 110 and the air is directed by the curvature of the hemispherical reflector 110 to flow out on the other side. A barrier 117 blocks the exiting air and reflects the air around to the outer surface of the reflector 110. In order to avoid blocking the light emitting from the lamp 120, the barrier 117 can be made of transparent materials or has an opening for letting the light pass through to reach the color wheel 200. The second fan 115 is configured to direct the air passing the lamp 120, with a relative high temperature, to the outer surface of the reflector 110. The second fan 115 also can pull the other portion of the air coming from the two air inlets 111, 112, with a relative low temperature, to pass a second hole 119 and cross the outer surface of the reflector 110. Thereby, the temperature of air passing across the outer surface of the reflector 110 is low enough to cool the outer surface of the reflector 110.

The speed of the first fan 114 and the second fan 115 can be configured to be controlled independently. The speeds of the first fan 114 and the second fan 115 are set according to the ideal working temperatures of the color wheel 200, the lamp 120, and the outer surface of the reflector 110. If the color wheel 200 and the lamp 120 are found to be operating at temperatures higher than their ideal working temperatures, the speed of the first fan 114 may be increased to compensate. If the temperature of the outer surface of the reflector 110 is higher than its ideal working temperature, the speed of the second fan 115 may be increased.

In the present embodiment, the second airflow channel 12 includes an air inlet 121 and an air outlet 122 formed in the casing 500. A third fan 123 is disposed in the second airflow channel 12. The third fan 123 is installed at the air outlet 122 for pulling air, flowing in the second airflow channel 12, out of the projector 10. The speed of the third fan 123 is set according to the ideal working temperature of the DMD 400. The speed of the third fan 123 may be increased when it is found that the DMD 400 is operating at a temperature higher than its ideal working temperature.

The projector 10 can also have a number of temperature sensors installed therein for sensing the temperature of the components received therein.

The projector 10 has a first airflow channel 11 for cooling the light source 100 and the color wheel 200, a second airflow channel 12 for cooling the DMD 400. The speed of the airflows inside the first airflow channel 11 and the second airflow channel 12 can be controlled independently, so, the temperature of the DMD 400, the light source 100 and the color wheel 200 can be controlled independently. Furthermore, in the first airflow channel 11, the airflow passes through the color wheel 200 before passing by the light source 100, so that the temperature of the color wheel 200 can be controlled lower than that of the light source 100 which can withstand a relative high temperature.

A method for cooling a project using zone cooling is also provided. The method includes steps of: providing a first airflow channel 11 for cooling the light source 100 and the color wheel 200; providing a second airflow channel 12 for cooling the Digital Mirror Device 400, the second airflow channel 12 is independent to the first airflow channel 11.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. A projector comprising:
a light source;
a color wheel for providing rapid color changes in light emitted from the light source; and
a Digital Mirror Device for forming an optical image according to image information by using light emitted from the light source,
wherein the projector is further constructed to comprise a first airflow channel for cooling the light source and the color wheel and a second airflow channel for cooling the Digital Mirror Device, the first airflow channel and the second airflow channel are independent of each other.

2. The projector as claimed in claim 1, wherein the color wheel and the light source are arranged inside the first airflow channel along an airflow direction thereof.

3. The projector as claimed in claim 1, wherein the light source includes a reflector and a lamp received in the inner side of the reflector, the first airflow channel includes at least one air inlet, an air outlet, a first fan, and a second fan, the first fan being configured for directing a portion of air coming from the air inlet through the color wheel and the lamp in that order, the second fan being configured for directing the air passing by the lamp and the other portion of the air coming from the air inlet passing by the outer surface of the reflector and exiting the projector through the air outlet.

4. The projector as claimed in claim 3, wherein the first fan is attached to an air inlet which is perpendicular to the second fan.

5. The projector as claimed in claim 3, wherein the speed of the first fan is increased when a temperature of the color wheel and/or the lamp is higher than their ideal working temperature respectively.

6. The projector as claimed in claim 3, wherein the speed of the second fan is increased when a temperature of an outer surface of the reflector is higher than its ideal working temperature.

7. The projector as claimed in claim 1, wherein the second airflow channel comprises an air inlet, an air outlet and a third fan disposed in the second airflow channel, the third fan being installed at the air outlet for pulling air inside of the second airflow channel out of the projector.

8. The projector as claimed in claim 7, wherein the speed of the third fan is increased when a temperature of the Digital Mirror Device is higher than its ideal working temperature.

9. The projector as claimed in claim 1, wherein the projector has a number of temperature sensors for sensing temperature of components therein.

10. A method for cooling a projector as described in claim 1, the method comprising the step of:
providing a plurality of airflow channels to cool the projector, wherein the plurality of airflow channels are independent of each other.

11. The method as claimed in claim 10, wherein the light source and the color wheel are arranged inside one airflow channel and the Digital Mirror Device is arranged in another airflow channel.

12. The method as claimed in claim 10, wherein the airflow in each airflow channel is directed by using at least one fan installed therein.

13. The method as claimed in claim 12, wherein the temperature in each airflow channel is adjusted by adjusting the speed of the at least one fan.
